(19) United States
(12) Patent Application Publication
(10) Pub. No.: US 2026/0149768 A1
(43) Pub. Date: May 28, 2026

(54) ELECTRONIC DEVICE COMPRISING DISPLAY FOR DISPLAYING CONTENT BASED ON CASE

(71) Applicant: SAMSUNG ELECTRONICS CO., LTD., Suwon-si (KR)

(72) Inventors: Youngoh KIM, Suwon-si (KR); Jaejun SIN, Suwon-si (KR); Moohyun ROH, Suwon-si (KR); Jingeun GWON, Suwon-si (KR); Joohoan DO, Suwon-si (KR); Jeonghun SEO, Suwon-si (KR); Junho YE, Suwon-si (KR); Inhyung JUNG, Suwon-si (KR); Sungwan HONG, Suwon-si (KR); Jeongseok PARK, Suwon-si (KR)

(21) Appl. No.: 19/451,805

(22) Filed: Jan. 16, 2026

Related U.S. Application Data
(63) Continuation of application No. PCT/KR2024/007630, filed on Jun. 4, 2024.

(30) Foreign Application Priority Data
Jul. 17, 2023 (KR) 10-2023-0092272
Jul. 19, 2023 (KR) 10-2023-0094086

(51) Int. Cl. H04M 1/72412; H04M 1/02; H04M 1/72454

(52) U.S. Cl. CPC H04M 1/72412; H04M 1/0216; H04M 1/72454

(57) ABSTRACT

This electronic device comprises: a first housing and a second housing which are rotatably coupled; a cover display; a first sensor; first wireless communication circuitry which communicates through a first antenna; a memory which stores instructions; and a processor. The processor is configured to: establish a communication channel with an outer case on the basis of identifying, through the first sensor, the coupling of the outer case to the electronic device; acquire an identifier assigned to the outer case and data related to content; identify content to be displayed through the cover display; control the cover display so that the content is displayed through the cover display; and while the content is being displayed through the cover display, estimate the state of charge (SOC) of a battery.

### CROSS-REFERENCE TO RELATED APPLICATIONS

This application is a continuation of International Application No. PCT/KR2024/007630, designating the United States, filed on Jun. 4, 2024, in the Ministry of Intellectual Property, and claiming priority to Korean Patent Application Nos. 10-2023-0094086 filed on Jul. 19, 2023, and 10-2023-0092272 filed on Jul. 17, 2023, in the Ministry of Intellectual Property, the disclosures of each of which are incorporated by reference herein in their entireties.

### BACKGROUND

### Field

The present disclosure relates to an electronic device including a display for displaying content based on a case.

### Description of Related Art

As demand for a highly portable electronic device increases, an electronic device may include a deformable display. The deformable display may be configured to be foldable. The electronic device including the deformable display may include housings that are rotatably coupled to each other. In a folded state of the housings, the electronic device may include a cover display exposed to the outside.

The above-described information may be provided as related art for the purpose of helping the understanding of the present disclosure. No claim or determination is raised as to whether any of the above-described content may be applied as prior art related to the present disclosure.

### SUMMARY

An electronic device is provided. The electronic device may comprise a first housing part. The electronic device may comprise a second housing part rotatably connected to the first housing part. The electronic device may be disposed on at least a portion of a surface of the first housing part. The electronic device may comprise a first sensor. The electronic device may comprise first wireless communication circuitry configured to communicate using a first antenna. The electronic device may comprise memory including one or more storage media storing instructions. The electronic device may comprise a processor including processing circuitry. The instructions, when executed by the processor individually or collectively, may cause the electronic device to, based on identifying coupling between a case coupled to the electronic device and the second housing part, establish a communication channel with the case via the first antenna and the first wireless communication circuitry. The instructions, when executed by the processor individually or collectively, may cause the electronic device to obtain an identifier assigned to the case and data related to content via the communication channel. The instructions, when executed by the processor individually or collectively, may cause the electronic device to identify content to be displayed via the cover display based on the data. The instructions, when executed by the processor individually or collectively, may cause the electronic device to control the cover display such that the identified content is displayed via the cover display. The processor may cause the electronic device to estimate state of charge (SOC) of a battery while the content is displayed via the cover display.

A method for an electronic device is provided. The method may comprise identifying coupling between a case and the electronic device via a first sensor, establishing a communication channel with the case via a first antenna and first wireless communication circuitry of the electronic device, obtaining an identifier assigned to the case and data related to the content via the communication channel, identifying content to be displayed via a cover display of the electronic device based on the obtained data, controlling the cover display such that the identified content is displayed via the cover display, and estimating state of charge (SOC) of a battery of the electronic device while the content is displayed via the cover display.

### BRIEF DESCRIPTION OF THE DRAWINGS

FIG. 1 is a block diagram of an electronic device in a network environment according to various embodiments.

FIG. 2 is a simplified block diagram of an electronic device, a case, and an external electronic device.

FIG. 3A illustrates an unfolded state of an electronic device according to an embodiment.

FIG. 3B illustrates intermediate states and a folded state of an electronic device according to an embodiment.

FIG. 4A illustrates an electronic device and a case according to an embodiment.

FIG. 4B illustrates an electronic device and an external object according to an embodiment.

FIG. 5 is a flowchart of an operation of displaying content via a cover display of an electronic device according to an embodiment.

FIG. 6A illustrates a process in which content is displayed on a cover display.

FIG. 6B illustrates an unfolded state of an electronic device according to an embodiment.

FIG. 7 is a flowchart of an operation in which an electronic device according to an embodiment authenticates a case.

FIG. 8 is a flowchart of an operation of changing content based on SOC of a battery.

FIG. 9A is a flowchart of an operation of an electronic device according to a type of content displayed on the electronic device according to an embodiment.

FIG. 9B schematically illustrates a process of displaying first content via a cover display.

FIG. 9C schematically illustrates a process of displaying second content via a cover display.

FIG. 9D illustrates an example of a visual object for notifying an application of second content.

FIG. 10 is a flowchart of an operation of deleting second content of an electronic device according to an embodiment.

FIG. 11 is a flowchart of an operation based on a state of an electronic device according to an embodiment.

FIG. 12 illustrates an exemplary process for changing content displayed on a cover display.

FIG. 13 is a flowchart of an operation of changing content based on an external environment.

### DETAILED DESCRIPTION

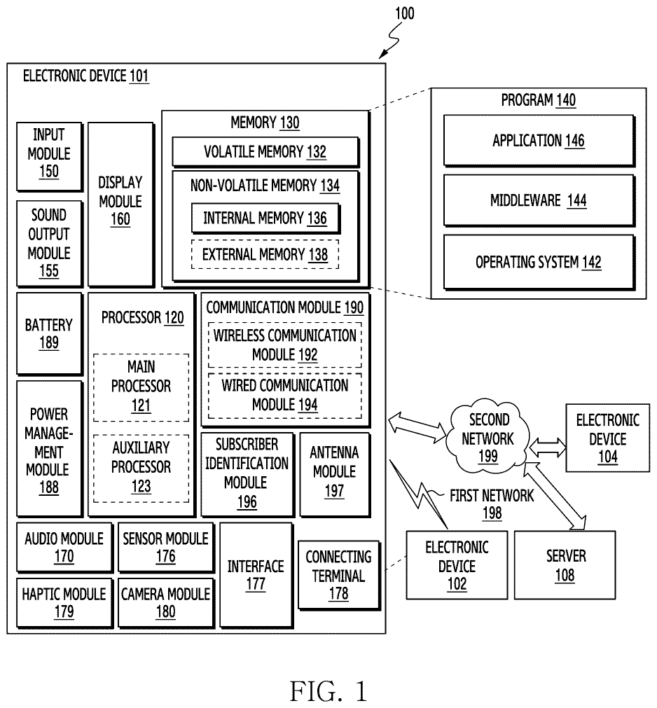

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

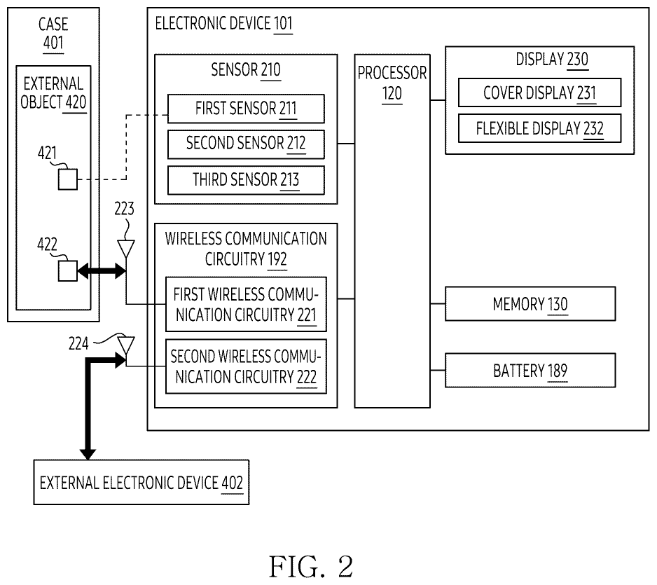

FIG. 2 is a simplified block diagram of an electronic device, a case, and an external electronic device.

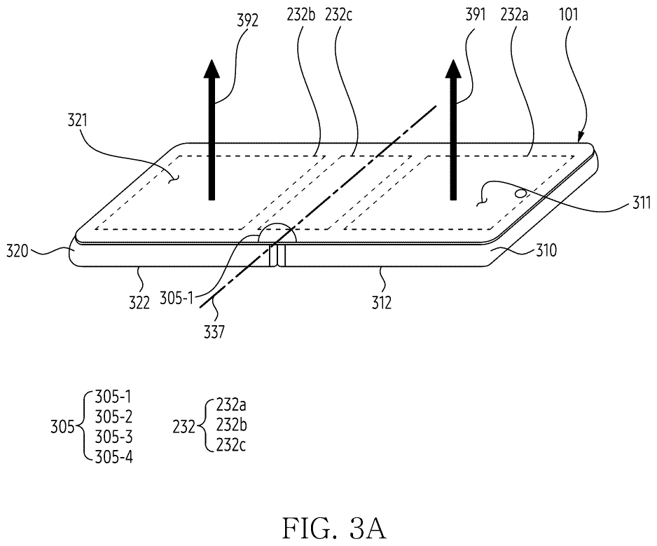

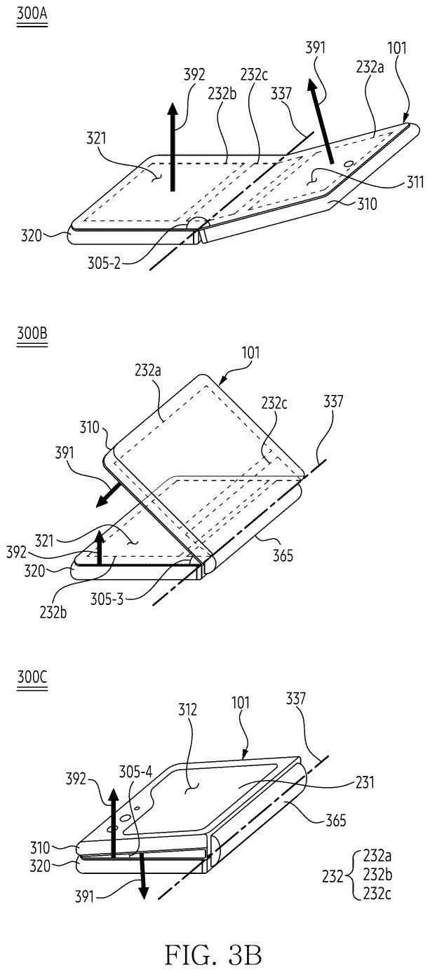

Referring to FIG. 2, an electronic device 101 may include a processor 120, a first housing part (e.g., a first housing part 310 of FIG. 3A), a second housing part (e.g., a second housing part 320 of FIG. 3A), a display 230, wireless communication circuitry 192, a sensor 210, memory 130, and/or a battery 189. Second wireless communication circuitry 222, a second sensor 212, and/or a third sensor 213 may be omitted. Although not illustrated, the electronic device 101 may include various components in addition to the components described above. The processor 120 may be referred to as at least one processor.

The electronic device 101 may include the first housing part (e.g., the first housing part 310 of FIG. 3A) and the second housing part (e.g., the second housing part 320 of FIG. 3A) rotatably coupled to each other. For example, the second housing part 320 may be rotatably coupled to the first housing part 310 with respect to a folding axis (e.g., a folding axis 337 of FIG. 3A). The first housing part 310 and the second housing part 320 will be described later with reference to FIGS. 3A and 3B.

The processor 120 may be operatively connected to a cover display 231, the wireless communication circuitry 192, the sensor 210, and/or the memory 130. The processor 120 being operatively connected to the memory 130, the cover display 231, the wireless communication circuitry 192, and/or the sensor 210 may mean that the processor 120 is directly connected to the components, or connected to the components via another component. For example, the processor 120 may be configured to control the cover display 231, the wireless communication circuitry 192, the sensor 210, and/or the memory 130. For example, the processor 120 may include a hardware component for processing data based on one or more instructions. The hardware component for processing data may include, for example, an arithmetic and logic unit (ALU), a field programmable gate array (FPGA), and/or a central processing unit (CPU). The processor 120 may cause an operation of the electronic device 101 by executing instructions stored in the memory 130. The operation of the processor 120 will be described later.

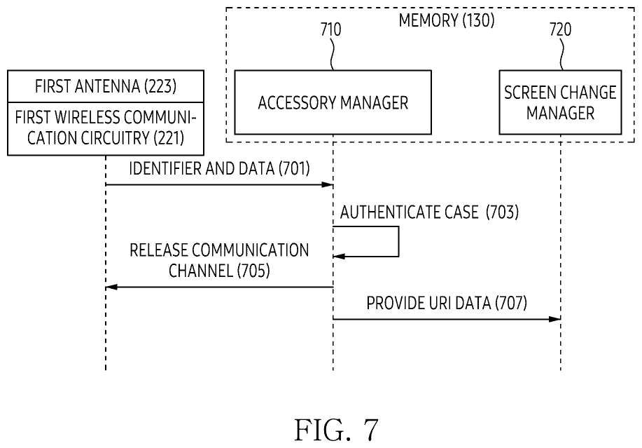

For example, the memory 130 (e.g., the memory 130 of FIG. 1) may be a volatile memory unit or units. For example, the memory 130 may be a non-volatile memory unit or units. For example, the memory 130 may be another form of computer-readable medium, such as a magnetic or optical disk. For example, the memory 130 may store data obtained based on an operation (e.g., an algorithm performance operation) performed by the processor 120. For example, the memory 130 may be used to store one or more programs (e.g., an accessory manager 710 and/or a screen change manager 720 of FIG. 7). The one or more programs, when executed by the processor 120 of the electronic device 101, may include instructions for performing a defined operation. When the instructions are executed by the processor 120, the operation of the electronic device 101 may be caused.

For example, in the memory 130, one or more instructions indicating a computation and/or an operation to be performed by the processor 120 on data may be stored. A set of one or more instructions may be referred to as firmware, an operating system, a process, a routine, a sub-routine, and/or an application. For example, when a set of a plurality of instructions distributed in a form of an operating system, firmware, a driver, and/or an application is executed, the electronic device 101 and/or the processor 120 may perform at least one of operations of the electronic device 101 described below. Hereinafter, an application being installed on the electronic device 101 may mean that one or more instructions provided in a form of an application are stored in the memory 130 of the electronic device 101, and that the one or more applications are stored in a format (e.g., a file having an extension designated by the operating system of the electronic device 101) executable by the processor 120 of the electronic device 101.

For example, the display 230 may include a flexible display 232 and the cover display 231. For example, the flexible display 232 may be visible from the outside of the electronic device 101 in an unfolded state and/or an intermediate state. For example, in a folded state, the flexible display 232 may not be visible from the outside of the electronic device 101 by being covered by the first housing part 310 and the second housing part 320. The flexible display 232 may be referred to as a main display.

For example, the cover display 231 may be visible from the outside independently of a state (e.g., a folded state, an unfolded state, and/or a partially folded state) of the electronic device 101. For example, the cover display 231 may be disposed on an outer surface of the first housing part 310. For example, by being disposed on a second surface (e.g., a second surface 312 of FIG. 3B) of the first housing part 310, the cover display 231 may always be visible from the outside, independently of the state of the electronic device 101. The cover display 231 may be referred to as an external display or a sub-display. An example of the cover display 231 will be exemplified in FIG. 3B.

For example, the electronic device 101 may include the wireless communication circuitry 192 to be used for communication with an external electronic device 402. For example, the communication circuitry may be used for various radio access technologies (RATs). According to an embodiment, the wireless communication circuitry 192 may include first wireless communication circuitry 221 and/or the second wireless communication circuitry 222. For example, the first wireless communication circuitry 221 may be used to perform near field communication (NFC). For example, the second wireless communication circuitry 222 may be used to perform cellular communication and/or wireless LAN communication with the external electronic device 402.

For example, the sensor 210 may generate electronic information, which may be processed by the processor 120 and/or the memory 130, from non-electronic information related to the electronic device 101. The electronic information generated by the sensor 210 may be stored in the memory 130, processed by the processor 120, and/or transmitted to another electronic device that is distinct from the electronic device 101. For example, the sensor 210 may include one or more sensors.

For example, the sensor 210 may include a first sensor 211, the second sensor 212, and/or the third sensor 213. The electronic device 101 may be coupled to a case 401. For example, at least a portion of the electronic device 101 may be accommodated in the case 401. For example, the first sensor 211 may be used to identify coupling of the case 401. For example, the second sensor 212 may be used to identify a user input (e.g., a touch input) provided to the cover display. For example, the third sensor 213 may be used to identify the state (e.g., a folded state, an unfolded state, and/or an intermediate state) of the electronic device. A function of each of the first sensor 211, the second sensor 212, and/or the third sensor 213 will be described later.

For example, the battery 189 may be configured to store power and provide the stored power for various operations of the electronic device 101. For example, the battery 189 may include a rechargeable secondary cell. For example, the processor 120 may estimate state of charge (SOC) of the battery 189, which indicates remaining capacity relative to total capacity of the battery 189.

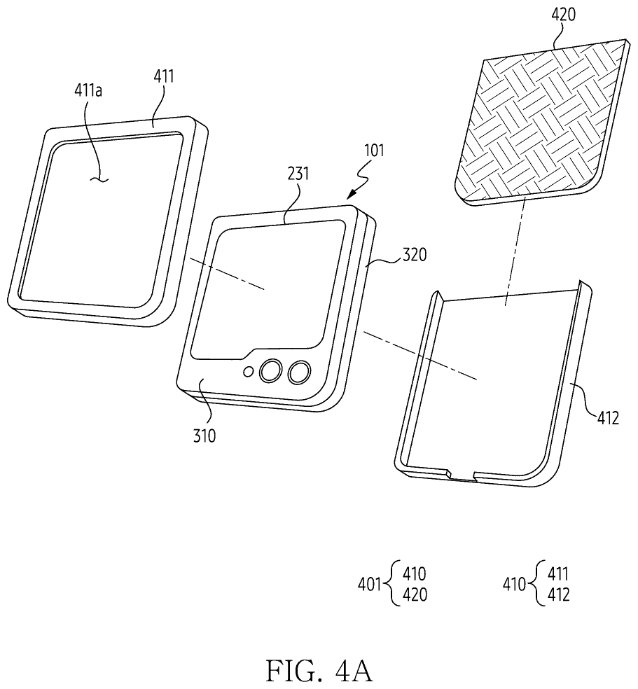

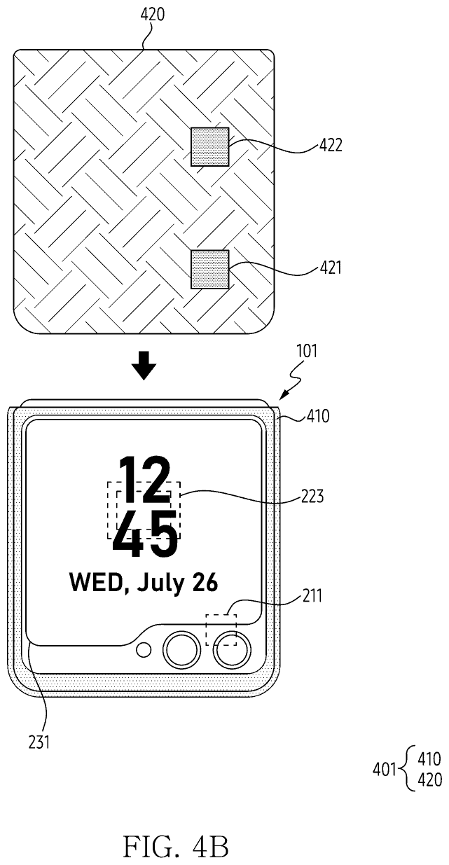

For example, the case 401 may be coupled to outer sides of the first housing part 310 and the second housing part 320. The case 401 may protect the electronic device 101 by at least partially covering the outer surface of the first housing part 310 and an outer surface of the second housing part 320. For example, the case 401 may include a frame (e.g., a frame 410 of FIG. 4A) and an external object 420. For example, the external object 420 may include a card and/or a palette, but is not limited thereto. For example, the external object 420 may include a detection object 421 and a chip 422 (e.g., an NFC chip). For example, the detection object 421 may include a magnet.

For example, when the detection object 421 is positioned in a designated distance from the electronic device 101, the processor 120 may identify that the detection object 421 is in the designated distance via the first sensor 211. For example, the processor 120 may be configured to identify that the external object 420 is coupled to the second housing part 320 based on identifying that the detection object 421 is in the designated distance via the first sensor 211. For example, the chip 422 may provide an identifier assigned to the case 401 and data related to the case 401 to the first wireless communication circuitry 221 using NFC. The identifier may be uniquely assigned to the case 401. The first wireless communication circuitry 221 may receive the identifier and the data through a first antenna 223 and provide the received identifier and the data to the processor 120.

The electronic device 101 according to an embodiment may display content to be displayed via the cover display 231 based on the data. For example, the content may include first content and second content. For example, the first content may be referred to as any one of contents pre-stored in the memory 130. For example, the second content may be referred to as content that may be downloaded from the external electronic device 402.

Hereinafter, an operation of displaying content on the cover display 231 will be described with reference to the drawings.

FIG. 3A illustrates an unfolded state of an electronic device according to an embodiment. FIG. 3B illustrates intermediate states and a folded state of an electronic device according to an embodiment.

Referring to FIGS. 3A and 3B, an electronic device 101 may be an example of the electronic device 101 of FIG. 1. For example, the electronic device 101 may include a first housing part 310 and a second housing part 320. The electronic device 101 may be referred to as a foldable electronic device.

For example, the first housing part 310 and the second housing part 320 may be rotatably coupled based on a folding axis 337. For example, the second housing part 320 may be rotatably coupled to the first housing part 310. For example, the electronic device 101 may include a hinge structure (e.g., a hinge structure 365 of FIG. 3B) for rotatably connecting the first housing part 310 and the second housing part 320. For example, the hinge structure 365 may enable the electronic device 101 to change from an unfolded state to a folded state. For example, the hinge structure 365 may enable the electronic device 101 to change from a folded state to an unfolded state. For example, the hinge structure 365 may maintain the electronic device 101 in an intermediate state between the unfolded state and the folded state. The intermediate state may be referred to as a state between the folded state and the unfolded state. The hinge structure 365 may be referred to as a hinge assembly.

For example, the first housing part 310 may include a first surface 311 and a second surface 312 opposite to the first surface 311. For example, the second housing part 320 may include a third surface 321 and a fourth surface 322 opposite to the third surface 321. For example, the first surface 311 and the third surface 321 may be referred to as a front surface of the first housing part 310 and a front surface of the second housing part 320, respectively. For example, the second surface 312 and the fourth surface 322 may be referred to as a rear surface of the first housing part 310 and a rear surface of the second housing part 320, respectively.

For example, the electronic device 101 may include a flexible display 232. The flexible display 232 may be disposed on the first housing part 310 (e.g., the first surface 311) and the second housing part 320 (e.g., the third surface 321). For example, the flexible display 232 may include a first display area 232a, a second display area 232b, and a third display area 232c. The first display area 232a may be disposed on the first surface 311 of the first housing part 310. The second display area 232b may be disposed on the third surface 321 of the second housing part 320. The third display area 232c may be disposed between the first display area 232a and the second display area 232b. The third display area 232c may be disposed along the folding axis 337.

The exemplary electronic device 101 may provide an unfolded state in which the first housing part 310 and the second housing part 320 are fully folded out by the hinge structure 365. For example, referring to FIG. 3A, the electronic device 101 may be in the unfolded state. For example, the unfolded state may mean a state in which a first direction 391 in which the first surface 311 faces, corresponds to a second direction 392 in which the third surface 321 faces. For example, in a state 300, the first direction 391 may be parallel to the second direction 392. For example, in the state 300, the first direction 391 may be identical to the second direction 392. The first direction 391 may correspond to a direction in which the first display area 232a faces, and the second direction 392 may correspond to a direction in which the second display area 232b faces.

In the unfolded state, the first surface 311 may form substantially the same plane as the third surface 321. For example, in the unfolded state, an angle 305-1 between the first surface 311 and the third surface 321 may be 180 degrees. For example, the unfolded state may mean a state in which an entire display area of the flexible display 232 may be substantially provided on one plane. For example, the unfolded state may mean a state in which the first display area 232a, the second display area 232b, and the third display area 232c may all be provided on one plane. For example, the unfolded state may be referred to as an outspread state or outspreading state. Hereafter, different states of the electronic device 101 based on angles 305-2, 305-3, and 305-4 will be described.

Referring to FIG. 3B, the electronic device 101 according to an embodiment may provide a folded state in which the first housing part 310 and the second housing part 320 are folded in by the hinge structure 365.

For example, the electronic device 101 may be in an intermediate state between the unfolded state and the folded state. For example, a state 300A and a state 300B may be referred to as the intermediate state. For example, a state 300C may be referred to as the folded state. In the intermediate state and the folded state, the first direction 391 in which the first surface 311 faces may be different from the second direction 392 in which the third surface 321 faces. For example, in the intermediate state and the folded state, the third display area 232c may be at least partially bent.

For example, in the state 300A, an angle between the first direction 391 and the second direction 392 may be approximately 45 degrees. For example, in the state 300B, an angle between the first direction 391 and the second direction 392 may be approximately 150 degrees. For example, in the folded state 300C, an angle between the first direction 391 and the second direction 392 may be substantially 180 degrees. For example, in the state 300A, an angle 305-2 between the first surface 311 and the third surface 321 may be 135 degrees. For example, in the state 300B, an angle 305-3 between the first surface 311 and the third surface 321 may be 30 degrees. For example, in the state 300C, an angle 305-4 between the first surface 311 and the third surface 321 may be substantially 0 degrees. For example, the folded state may provide the state 300C in which the first direction 391 is substantially opposite to the second direction 392. For example, the state 300C may mean a state in which the flexible display 232 is obscured from view of a user who is looking at the electronic device 101. However, it is not limited thereto.

The electronic device 101 according to an embodiment may display a screen via a cover display 231. The cover display 231 may always be visible from the outside, independently of the state of the electronic device 101. The cover display 231 may cover at least a portion of the rear surface of the first housing part 310. A case (e.g., a case 401 of FIG. 4A) may cover at least a portion of an outer surface of the first housing part 310 and an outer surface of the second housing part 320. For example, the case 401 may cover at least a portion of the second surface 312 and the fourth surface 322. The electronic device 101 may display a screen including content using the cover display 231 based on an external object (e.g., an external object 420 of FIG. 4A) positioned in a designated distance from the electronic device 101. For example, the external object 420 may be fixed via a frame 410 that is coupled to the electronic device 101.

FIG. 4A illustrates an electronic device and a case according to an embodiment. FIG. 4B illustrates an electronic device and an external object according to an embodiment.

Referring to FIG. 4A, an electronic device 101 according to an embodiment may include a first housing part 310 and a second housing part 320.

For example, a case 401 may include a frame 410 that forms an exterior appearance. For example, the frame 410 may include a first frame part 411 and a second frame part 412. For example, the first frame part 411 may cover at least a portion of the first housing part 310 by being coupled to an outer surface of the first housing part 310. For example, the first frame part 411 may include an opening 411a corresponding to the cover display 231 so that a cover display 231 is visible from the outside. The cover display 231 may be exposed to the outside of the case 401 via the opening 411a. A size of the first frame part 411 may correspond to a size of the first housing part 310. For example, the second frame part 412 may cover at least a portion of the second housing part 320 by being coupled to an outer surface of the second housing part 320. The size of the second frame part 412 may correspond to the size of the second housing part 320.

The case 401 may include an external object 420. For example, the external object 420 may be disposed between the second housing part 320 and the frame 410 by being coupled to the frame 410. For example, since the first frame part 411 is coupled to the outer surface of the first housing part 310 in which the cover display 231 is disposed, the external object 420 may be inserted into the second frame part 412. The second frame part 412 may be coupled to the outer surface of the second housing part 320 with the external object 420 inserted. For example, the second frame part 412 may include a slot into which the external object 420 may be inserted. For example, the slot may include a guide portion in which the external object 420 may be slid and fixed to the second frame part 412. A portion of a periphery of the external object 420 may be coupled to the guide portion by means of an interference fit (also known as a press fit or friction fit).

Referring to FIG. 4B, the external object 420 may include a detection object 421 and a chip 422. The detection object 421 and the chip 422 may be disposed at designated positions inside the external object 420. For example, the chip 422 may include a variety of information. For example, the chip 422 may include an identifier of the case 401 and data related to the case 401.

For example, the electronic device 101 may include a first sensor 211 for identifying that the detection object 421 is positioned in a designated distance, and a first antenna 223 for receiving a wireless signal from the chip 422. For example, a position of the first sensor 211 may correspond to a position of the detection object 421, and a position of the first antenna 223 may correspond to a position of the chip 422. For example, when the external object 420 is inserted into the frame 410, the detection object 421 may at least partially overlap with the first sensor 211, and the chip 422 may at least partially overlap with the first antenna 223. For example, the first antenna 223 may be disposed in the second housing part (e.g., the second housing part 320 of FIG. 3A).

For example, the case 401 may be substantially transparent. For example, a surface of the external object 420 may include an image. When the external object 420 is disposed in the second frame part 412 in a posture in which the surface faces the outside of the electronic device 101, the image in the surface may be visible via the substantially transparent second frame part (e.g., the second frame part 412 of FIG. 4A). The image included in the surface may provide various visual effects to a user. For example, since the user may select the external object 420 including an image that suits the user's preference and insert it into the second frame part 412, the case 401 may provide an enhanced user experience.

For example, a processor (e.g., the processor 120 of FIG. 2) may identify content based on data obtained via the first antenna 223 from the chip 422 of the external object 420. The processor 120 may be configured to control the cover display 231 such that the identified content is displayed via the cover display 231. For example, the content may include content corresponding to the image included in the surface of the external object 420. The content and the image included in the surface of the external object 420 may provide a visual effect provided to the outside of the electronic device 101, via the cover display 231. The electronic device 101 according to an embodiment may provide an enhanced user experience via the visual effect.

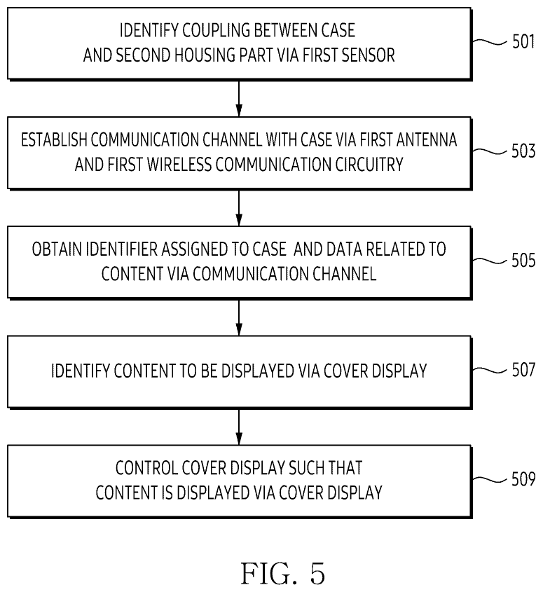

FIG. 5 is a flowchart of an operation of displaying content via a cover display of an electronic device according to an embodiment.

Operations described in FIG. 5 may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 5, in operation 501, the processor (e.g., the processor 120 of FIG. 2) may identify coupling between a case (e.g., the case 401 of FIG. 2) and a second housing part (e.g., the second housing part 320 of FIG. 3A) via a first sensor (e.g., the first sensor 211 of FIG. 2).

For example, when the case 401 is positioned in (or within) a designated distance from the electronic device (e.g., the electronic device 101 of FIG. 2), the first sensor 211 may provide an electrical signal to the processor 120 based on a detection object (e.g., the detection object 421 of FIG. 4B) positioned in a frame (e.g., the frame 410 of FIG. 4B). For example, the detection object 421 may include a magnet, and the first sensor 211 may include a Hall sensor that provides an electrical signal indicating a change in a magnetic field caused by the magnet. For example, when a second frame part (e.g., the second frame part 412 of FIG. 4A), into which an external object 420 is inserted, is coupled to an outer surface of the second housing part 320, the Hall sensor may provide an electrical signal to the processor 120 based on the change in the magnetic field caused by the magnet positioned in the designated distance. The processor 120 may be configured to identify that the case 401 is coupled to the second housing part 320 based on the electrical signal provided from the Hall sensor.

In operation 503, the processor 120 may establish a communication channel with the case 401 via a first antenna (e.g., the first antenna 223 of FIG. 2) and first wireless communication circuitry (e.g., the first wireless communication circuitry 221 of FIG. 2).

For example, the first antenna 223 may include an NFC antenna used for near field communication. For example, the processor 120 may activate the first antenna 223 to establish a communication channel based on identifying the coupling of the case 401. For example, when a chip (e.g., the chip 422 of FIG. 4B) positioned in the frame 410 is positioned in a designated distance (e.g., approximately 10 cm) from the activated first antenna 223, an NFC communication channel for transmitting information (e.g., an identifier assigned to the case 401 and data related to content) included in the chip 422 may be established.

In operation 505, the processor 120 may obtain the identifier assigned to the case 401 and data related to the case 401 via the established communication channel.

For example, the first wireless communication circuitry 221 may include NFC communication circuitry. The first wireless communication circuitry 221 may receive the identifier assigned to the case 401 and the data related to the content from the chip 422 included in the frame 410 via the established communication channel.

For example, the identifier assigned to the case 401 may be used to distinguish a type of the case 401. For example, the identifier may be used for authentication of the case 401.

In operation 507, the processor 120 may identify content to be displayed via a cover display (e.g., the cover display 231 of FIG. 2).

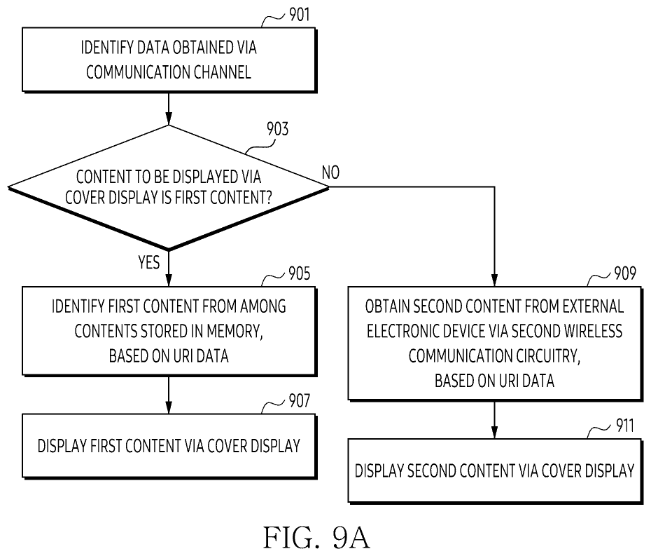

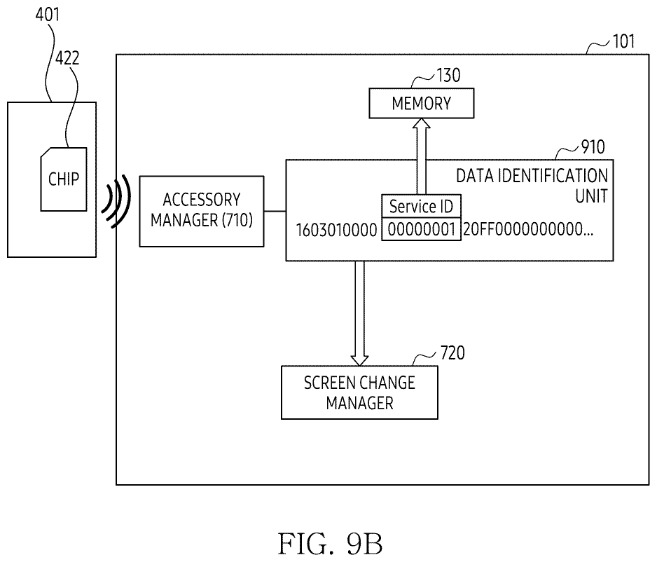

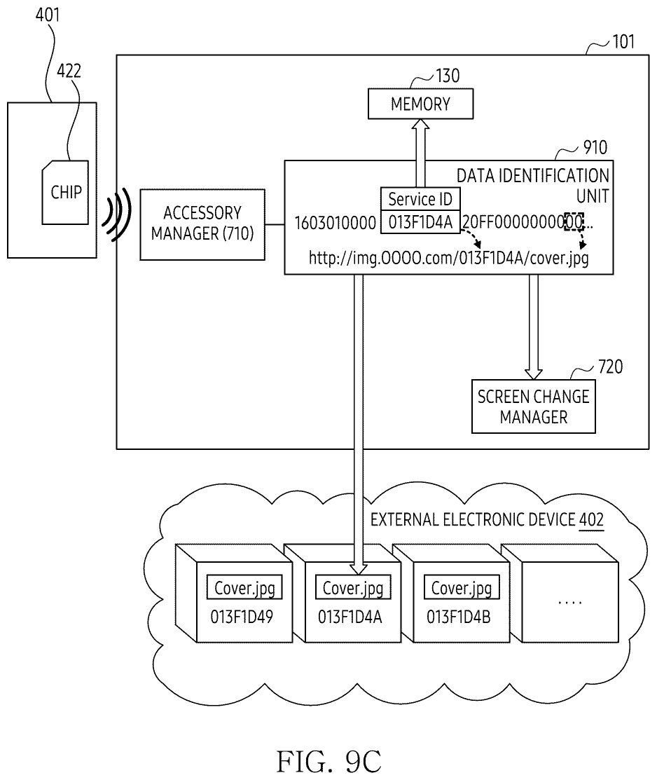

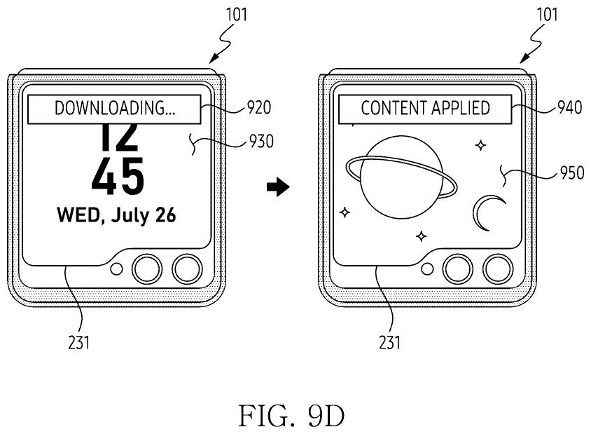

For example, data related to the content may include data related to content to be displayed via the cover display 231. For example, the content may include first content and second content. The first content will be described with reference to FIGS. 9A and 9B. The second content will be described with reference to FIGS. 9A and 9C. The data related to content may include information on the content to be displayed on the cover display 231. The processor 120 may identify the content to be displayed via the cover display 231 based on the obtained data. For example, the processor 120 may identify whether the information on the content included in the obtained data indicates the first content or the second content.

In operation 509, the processor 120 may control the cover display 231 such that the content is displayed via the cover display 231. The cover display 231 may be configured to display the content. When the content is displayed on the cover display 231, the content may be visible from the outside of the electronic device 101. A user may select an external object 420 for displaying content that suits their preferences and insert it into the frame 410. The user may express their individuality via the content displayed on the cover display 231. The electronic device 101 according to an embodiment may provide an enhanced user experience.

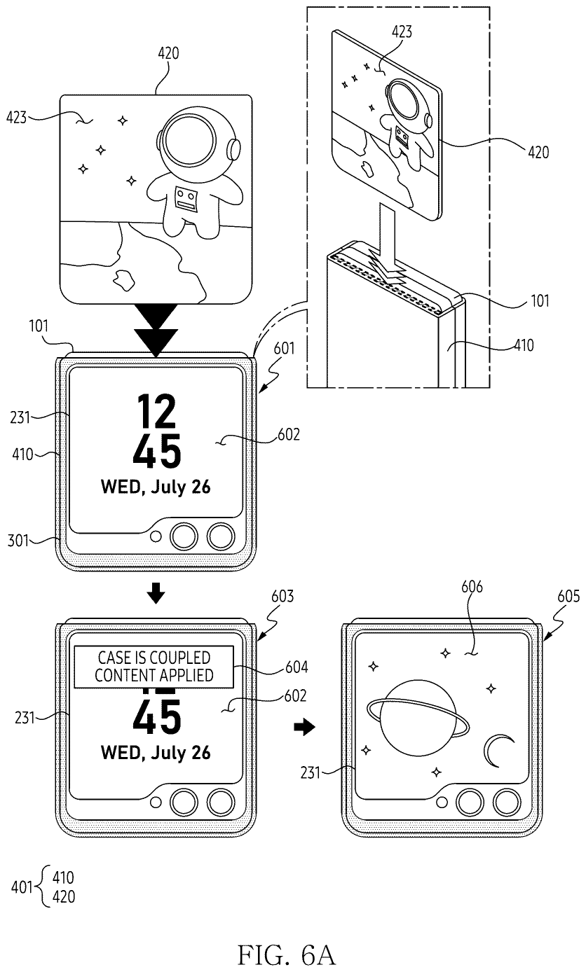

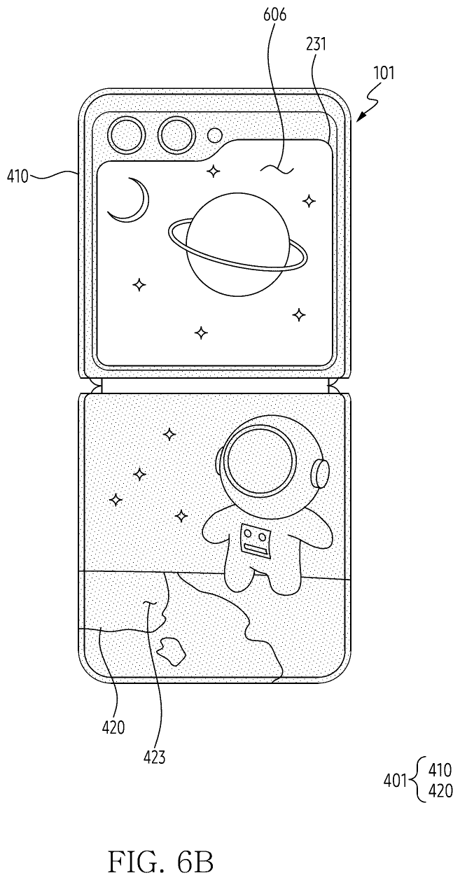

FIG. 6A illustrates a process in which content is displayed on a cover display. FIG. 6B illustrates an unfolded state of an electronic device according to an embodiment.

Referring to FIG. 6A, an external object 420 may be inserted into a frame 410 coupled to an electronic device 101. A state 601 of FIG. 6A indicates the electronic device 101 with a case 401 coupled to the electronic device 101 before the external object 420 is inserted. A state 603 of FIG. 6A indicates the electronic device 101 after the external object 420 is inserted and before displaying content via a cover display 231. A state 605 of FIG. 6A indicates the electronic device 101 displaying the content via the cover display 231.

Referring to FIG. 6A, in the state 601, the electronic device 101 may be in a state in which it is coupled to the case 401. The external object 420 may be inserted into the frame 410 coupled to the electronic device 101. When the external object 420 is inserted into the frame 410, a first sensor (e.g., the first sensor 211 of FIG. 4B) may provide an electrical signal to a processor (e.g., the processor 120 of FIG. 2) based on a detection object (e.g., the detection object 421 of FIG. 4B) included in the external object 420. The processor 120 may identify the coupling of the case 401 by identifying the insertion of the external object 420 via the first sensor 211. In FIG. 6A, the insertion of the external object 420 into the frame 410 is illustrated, but is not limited thereto. For example, the case 401 may also be coupled to the electronic device 101 in a state of being coupled to the external object 420.

For example, in the state 601, before the external object 420 is inserted into the frame 410, the processor 120 may display a basic screen 602 via the cover display 231. For example, the basic screen 602 may mean a screen that is basically provided via the cover display 231 of the electronic device 101. For example, the basic screen 602 may mean a screen that does not include content. The basic screen 602 via the cover display 231 may mean a screen that displays a day, a date, and/or time.

In the state 603, the processor 120 may identify that the case 401 is coupled. The processor 120 may establish a communication channel via a first antenna (e.g., the first antenna 223 of FIG. 4B) and first wireless communication circuitry (e.g., the first wireless communication circuitry 221 of FIG. 2). Via the established communication channel, the processor 120 may obtain an identifier assigned to the case 401 and data related to the content, which are included in a chip (e.g., the chip 422 of FIG. 4B). For example, the processor 120 may obtain the identifier assigned to the case 401 and the data related to the content via NFC.

For example, the processor 120 may display a visual object (e.g., a user interface) 604 via the cover display 231. The visual object 604 may be overlappingly displayed on the basic screen 602. The visual object 604 may include text indicating that the case 401 is coupled and/or text indicating that the content may be displayed on the cover display 231. However, it is not limited thereto. Through the text, a user may recognize that the electronic device 101 has identified the coupling of the external object 420 and that the content may be displayed. In another example, the visual object may include text indicating that information related to the content is being obtained. The other example will be exemplified in FIG. 9D.

In the state 605, the processor 120 may display the content via the cover display 231. For example, the processor 120 may control the cover display 231 such that the content is identified via the cover display 231. For example, the processor 120 may change a screen displayed via the cover display 231 from the basic screen 602 to a screen 606 including the content, based on the obtained data related to the content; the data related to the content is obtained from the external object 420. For example, the processor 120 may maintain display of the content based on the case 401 maintaining a state of being coupled to the electronic device 101.

Referring to FIG. 6B, the content displayed via the cover display 231 may be related to an image 423 included in a surface of the external object 420. For example, the content may include a dynamic image (e.g., a video, a hologram, an animation, and/or a flash), and the image 423 included in the surface of the external object 420 may include a static image. The dynamic image included in the content may be related to the static image 423. For example, the content may include a dynamic image related to a sense of color, a character, an atmosphere, a background, and/or a shape included in the static image.

The electronic device 101 according to an embodiment may provide a visual effect in which the static image is extended by providing content related to the static image included in the frame 410. The electronic device 101 according to an embodiment may provide an enhanced user experience.

FIG. 7 is a flowchart of an operation in which an electronic device according to an embodiment authenticates a case.

Operations described in FIG. 7 may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 7, the memory 130 of the electronic device (e.g., the electronic device 101 of FIG. 2) may store programs (e.g., an accessory manager 710 and a screen change manager 720) designed to change a screen of a cover display (e.g., the cover display 231 of FIG. 2). For example, the processor (e.g., the processor 120 of FIG. 2) may perform an operation for authenticating a case (e.g., the case 401 of FIG. 4A) coupled to the electronic device 101 (e.g., the electronic device 101 of FIG. 4A), and an operation for changing the screen displayed on the cover display 231, using the programs (e.g., the accessory manager 710 and the screen change manager 720) designed to change the screen of the cover display 231.

In operation 701, the processor 120 may provide an identifier of the case 401 and data related to the case 401 to the accessory manager 710 via a first antenna 223 and first wireless communication circuitry 221.

For example, the processor 120 may identify that a position of the case 401 is in a designated distance from the electronic device 101 using a first sensor (e.g., the first sensor 211 of FIG. 2). The processor 120 may activate the first antenna 223 based on identifying the coupling of the case 401 via the first sensor 211. A communication channel between the electronic device 101 and the case 401 may be established via the activated first antenna 223.

For example, the identifier may be stored in a chip 422 positioned in a frame 410. The processor 120 may obtain the identifier using a communication channel established via the first antenna 223 and the first wireless communication circuitry 221. The processor 120 may provide the obtained identifier to the accessory manager 710.

In operation 703, the processor 120 may perform authentication for the case 401 based on the identifier assigned to the case 401 using the accessory manager 710. For example, the authentication may indicate an operation in which the processor 120 identifies a type of the case 401 via the identifier assigned to the case 401. For example, the processor 120 may identify, via the identifier assigned to the case 401, whether the case 401 coupled to the electronic device 101 is the case 401 for changing the screen displayed via the cover display 231. For example, the processor 120 may identify, via the identifier assigned to the case 401, whether data related to content provided by the case 401 coupled to the electronic device 101 is secured data.

In operation 705, the processor 120 may release the communication channel established via the first antenna 223 and the first wireless communication circuitry 221, based on completion of the authentication for the case 401.

For example, the processor 120 may deactivate the first antenna 223 based on the completion of the authentication for the case 401. As the first antenna 223 is deactivated, the established communication channel may be released. For example, in a case that the communication channel is maintained while the coupling between the case 401 and the electronic device 101 is maintained, power may be continuously consumed. After the authentication is completed, by releasing the communication channel, unnecessary power consumption may be reduced. For example, in a case that the communication channel is maintained while the coupling between the case 401 and the electronic device 101 is maintained, it may be difficult to establish a communication channel with an external electronic device (e.g., a credit card reader device) via the first antenna 223. For example, the processor 120 may be configured to release the communication channel based on the completion of the authentication to enable various functions provided using NFC communication. After the authentication is completed, by releasing the communication channel, the electronic device 101 may perform NFC with the external electronic device using NFC.

In operation 707, the processor 120 may provide data related to content to the screen change manager 720 via the accessory manager 710, based on the authentication of the case 401. For example, the processor 120 may provide (e.g., broadcast) a uniform resource identifier (URI) to the screen change manager 720 via the accessory manager 710. Based on the URI, the processor 120 may change a screen of a display 230 via the screen change manager 720. For example, the screen change manager 720 may change the screen based on calling a wallpaper API. For example, the screen change manager 720 may identify first content to be displayed via the cover display 231 from among contents stored in the memory 130. For example, the screen change manager 720 may control the cover display 231 such that the identified first content is displayed via the cover display 231. For example, the screen change manager 720 may download second content from an external electronic device 402 (e.g., a server). For example, the screen change manager 720 may control the cover display 231 such that the downloaded second content is displayed via the cover display 231.

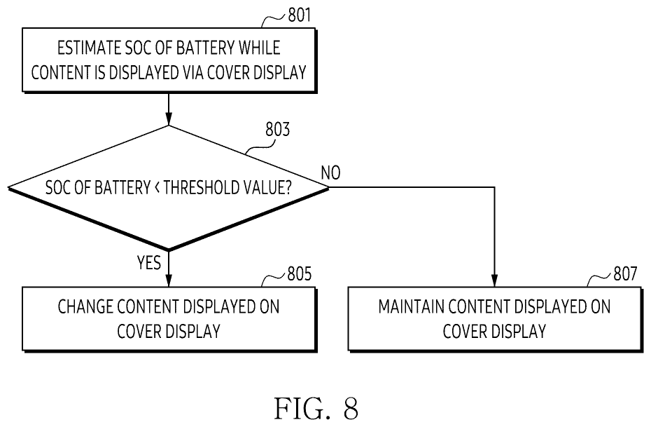

FIG. 8 is a flowchart of an operation of changing content based on SOC of a battery.

Operations described in FIG. 8 may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 8, in operation 801, the processor (e.g., the processor 120 of FIG. 2) may estimate SOC of a battery (e.g., the battery 189 of FIG. 2) while content is displayed via a cover display (e.g., the cover display 231 of FIG. 2).

For example, the processor 120 may estimate the SOC of the battery 189 that supplies power to at least one component (e.g., the cover display 231) of the electronic device (e.g., the electronic device 101 of FIG. 2). For example, the processor 120 may estimate the SOC of the battery 189, which indicates remaining capacity relative to total capacity of the battery 189, using a current integration method, an electrical circuit model method, an electrochemical model method, and/or a data-based method. For example, the SOC may be calculated as a percentage (unit: %) of the remaining capacity relative to the total capacity of the battery 189.

In an operation 803, the processor 120 may identify whether the SOC of the battery 189 is less than a threshold value.

For example, the processor 120 may compare the SOC of the battery 189 with a pre-stored threshold value. For example, the threshold value may be referred to as SOC indicating a low power state of the battery 189. For example, the threshold value may be referred to as SOC at which the discharge capacity (or remaining capacity) of the battery 189 is determined to be insufficient. For example, the threshold value may be SOC of 20%, but is not limited thereto. If the SOC of the battery 189 is less than the threshold value, the processor 120 may perform operation 805. If the SOC of the battery 189 is equal to or greater than the threshold value, the processor 120 may perform operation 807.

In operation 805, the processor 120 may change the content displayed on the cover display 231.

For example, the content displayed on the cover display 231 may include a dynamic image. For example, since a dynamic image includes a plurality of frames displayed over time, relatively high power consumption may be caused (or used) while the dynamic image is displayed on the cover display 231. The processor 120 may be configured to change the dynamic image to a static image based on estimating that the SOC of the battery 189 is less than the threshold value. For example, since the static image includes a single frame, relatively low power consumption may be caused (or used) while the static image is displayed on the cover display 231. In a situation in which the SOC of the battery 189 is insufficient, the power consumption of the battery 189 may be reduced as the content displayed via the cover display 231 is changed from the dynamic image to the static image. However, it is not limited thereto. For example, the processor 120 may be configured to reduce a tone (e.g., brightness and/or saturation) of the content based on estimating that the SOC of the battery 189 is less than the threshold value. As the tone of the content is reduced, the power consumption of the battery 189 may be reduced. The reduction in the power consumption may increase a time required for the SOC of the battery 189 to be fully discharged (e.g., the SOC of the battery can be extended before being fully discharged).

In operation 807, the processor 120 may maintain the content displayed on the cover display 231.

For example, if the SOC of the battery 189 is equal to or greater than the threshold value, the remaining capacity of the battery 189 may be sufficient. Since the remaining capacity of the battery 189 is sufficient, even when content that causes relatively high power consumption is displayed via the cover display 231, the battery 189 may not be fully discharged. Based on estimating SOC equal to or greater than the threshold value, the processor 120 may provide an enhanced user experience by maintaining the content displayed on the cover display 231.

FIG. 9A is a flowchart of an operation of an electronic device according to a type of content displayed on the electronic device according to an embodiment. FIG. 9B schematically illustrates a process of displaying first content via a cover display. FIG. 9C schematically illustrates a process of displaying second content via a cover display. FIG. 9D illustrates an example of a visual object for notifying an application of second content.

Operations described in FIG. 9A may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 9A, in operation 901, the processor (e.g., the processor 120 of FIG. 2) may identify data obtained via a communication channel.

For example, the processor 120 may obtain data related to content via the communication channel. For example, the data may include information related to the content. For example, the information related to the content may be referred to as information indicating whether content to be displayed via a cover display (e.g., the cover display 231 of FIG. 2) is first content or second content when a case (e.g., the case 401 of FIG. 2) is coupled. The processor 120 may be configured to identify whether the content to be displayed via the cover display 231 is the first content or the second content, based on the data obtained via a first antenna (e.g., the first antenna 223 of FIG. 2) and first wireless communication circuitry (e.g., the first wireless communication circuitry 221 of FIG. 2).

For example, the content to be displayed via the cover display 231 may include the first content and the second content. For example, the first content may be referred to as content corresponding to the data from among contents pre-stored in the memory (e.g., the memory 130 of FIG. 2). For example, the second content may be referred to as content downloaded via an external electronic device (e.g., the external electronic device 402 of FIG. 2) (e.g., a server) based on the data. The second content may be referred to as content stored in the memory 130 by being downloaded. For example, the first content may be referred to as a preload content (or preloaded content), and the second content may be referred to as a download content (or downloaded content).

In operation 903, the processor 120 may identify whether the content to be displayed via the cover display 231 is the first content, based on the identified data. For example, the processor 120 may identify whether the identified content is the first content or the second content, based on the information related to the content included in the data. When the content identified in the operation 903 is the first content, the processor 120 may perform operation 905.

In the operation 905, the processor 120 may identify the first content from among contents stored in the memory 130, based on URI data.

For example, the processor 120 may identify the first content corresponding to URI data obtained from a chip (e.g., the chip 422 of FIG. 4B) inside the case 401 from among contents stored in the memory 130. For example, the first content may be related to an image included in a surface of an external object (e.g., the external object 420 of FIG. 4A) inserted into a frame (e.g., the frame 410 of FIG. 4A).

In operation 907, the processor 120 may display the first content via the cover display 231. For example, the processor 120 may control the cover display 231 such that the first content is displayed on the cover display 231.

Referring to FIG. 9B, the processor (e.g., the processor 120 of FIG. 2) may obtain data related to content from the case 401 including the chip 422 via NFC. For example, the data may include URI data having a size of 23 bytes. For example, a format of the URI data may be set as shown in the following Table 1. For example, the processor 120 may provide the URI data to a screen change manager 720 via an accessory manager 710.

TABLE 1

| | | | Data (Max 126 bytes) | | | |
|---|---|---|---|---|---|---|
| | | | Palette ID (21 bytes) | | | |
| | | | | Service | Service | Serial |
| | Length | Type | Version | Type | ID | No. |
| Allocated | 1 byte | 1 byte | 1 byte | 2 bytes | 4 bytes | 14 bytes |
| Byte Size | | | | | | |
| Value | 0x16 | Data | 0x01 | per | Unique ID | Custom Data |
| | (fixed | Processing | (fixed | Contents | per Card | per Card |
| | value) | Module | value) | Storage | Type | |
| Example | 16 | 1 | 1 | 00 00 | 00 00 00 | 02 00 00 |
| Format | | | | | 01 | 00 . . . 00 |
| (Hex) | | | | | | 01 |

In Table 1, the card may mean the external object 420. Referring to Table 1, the URI data having a size of 23 bytes may include a length field, a type field, a version field, a service type field, a service ID field, and a serial number field.

For example, the URI data length field may be set to a fixed value (e.g., 0x16). For example, the type field may be set to indicate which application (or module) should process the data obtained from the case 401. For example, the version field may be set to a fixed value. For example, the service type field may indicate information on the content described above. For example, the service type field may indicate information indicating whether the content provided from the chip 422 is the first content or the second content. For example, the service ID field may indicate a unique ID for each type of the case 401 (or the external object 420). For example, in a case of the first content, from among contents stored in the memory 130, any one content indicated by the service ID field may be specified. For example, in a case of the second content, from among contents stored in the external electronic device 402 (e.g., a server), any one content indicated by the service ID field may be specified. For example, the serial number field may be used to specify a screen for displaying the content. However, it is not limited thereto.

For example, the processor 120 may provide the URI data to a data identification unit 910 via the accessory manager 710. The processor 120 may identify the service ID field included in the URI data via the data identification unit 910. The processor 120 may identify the first content stored in the memory 130 based on a value of the service ID field. The processor 120 may provide information on a screen including the first content to the screen change manager 720. The processor 120 may change a screen of the cover display 231 to a screen including the first content via the screen change manager 720.

Referring again to FIG. 9A, when the content identified in the operation 903 is not the first content (i.e., when the identified content is the second content), the processor 120 may perform operation 909.

In the operation 909, the processor 120 may obtain the second content from the external electronic device 402 via second wireless communication circuitry (e.g., the second wireless communication circuitry 222 of FIG. 2), based on the URI data.

For example, the processor 120 may identify the second content corresponding to the URI data obtained from the chip 422 from among contents stored in the external electronic device (e.g., the external electronic device 402 of FIG. 2). For example, the second content may be related to the image included in the surface of the external object 420 inserted into the frame 410.

In operation 911, the processor 120 may display the second content via the cover display 231. For example, the processor 120 may control the cover display 231 such that the second content is displayed on the cover display 231.

Referring to FIG. 9C, the processor 120 may obtain the data related to the content from the chip 422 of the case 401 via NFC. For example, the data may include the URI data having a size of 23 bytes. For example, the processor 120 may provide the URI data to the screen change manager 720 via the accessory manager 710.

For example, the processor 120 may provide the URI data to the data identification unit 910 via the accessory manager 710. The processor 120 may identify the service ID field included in the URI data via the data identification unit 910. The processor 120 may obtain information on the second content to be downloaded via the external electronic device 402 (e.g., a server), based on a value of the service ID field. For example, the processor 120 may identify an address for downloading the information on the second content from the external electronic device 402, based on the value of the service ID field. As an example, the processor 120 may identify the value of the service ID field as a portion of the address. For example, the processor 120 may obtain the second content from the external electronic device 402.

For example, the electronic device 101 may include a second antenna (e.g., the second antenna 224 of FIG. 2) and the second wireless communication circuitry 222. For example, the second antenna 224 and the second wireless communication circuitry 222 may be used to perform cellular communication and/or wireless LAN communication with the external electronic device 402. For example, the processor 120 may download the second content stored at the identified address via the second antenna 224 and the second wireless communication circuitry 222. For example, the downloaded second content may be stored in the memory 130. The processor 120 may provide the second content to the screen change manager 720. The processor 120 may change the screen of the cover display 231 to a screen including the second content via the screen change manager 720.

Referring to FIG. 9D, the electronic device 101 may display a visual object 920 indicating that information on the second content is being obtained, via the cover display 231. For example, the visual object 920 may include text such as “Downloading . . . ”. The visual object 920 may be overlappingly displayed with a basic screen 930. As the visual object 920 including the text is displayed, a user may recognize that the second content is being downloaded from the external electronic device (e.g., the external electronic device 402 of FIG. 9C). As the download of the second content is completed, in a state in which display of the second content is available via the cover display 231, the electronic device 101 may display, via the cover display 231, a visual object 940 indicating that display of the second content is available. For example, the visual object 940 may include text such as “Content applied”. For example, the visual object 940 may be overlappingly displayed with a screen 950 including the second content. The visual object 940 may disappear after a designated time elapses.

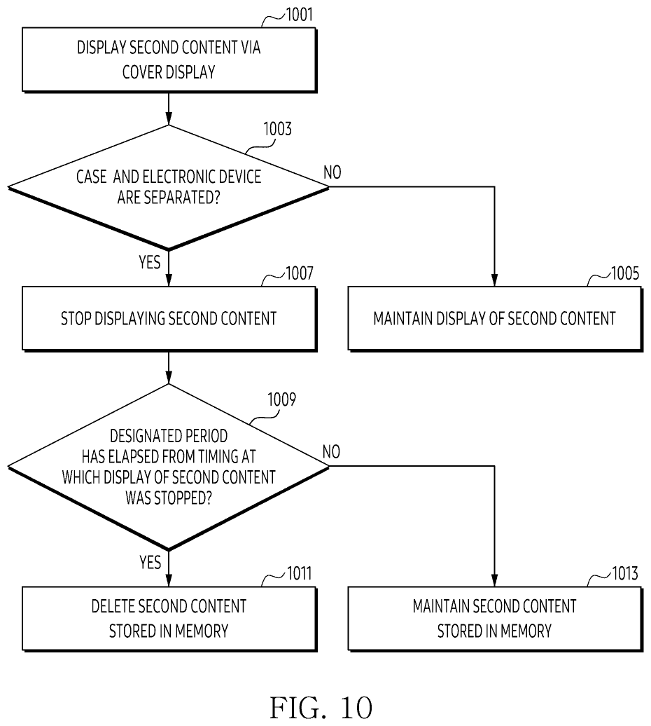

FIG. 10 is a flowchart of an operation of deleting second content of an electronic device according to an embodiment.

Operations described in FIG. 10 may be operations caused by an electronic device (e.g., the electronic device 101 of FIG. 2) when instructions stored in memory (e.g., the memory 130 of FIG. 2) are executed by a processor (e.g., the processor 120 of FIG. 2).

For example, second content may be obtained from a chip (e.g., the chip 422 of FIG. 4B) included in an external object (e.g., the external object 420 of FIG. 4B). For example, when the external object 420 is inserted into a frame (e.g., the frame 410 of FIG. 4A), the electronic device (e.g., the electronic device 101 of FIG. 2) may download the second content based on URI data obtained from the chip 422 included in the external object 420. To change content displayed on a cover display (e.g., the cover display 231 of FIG. 2), a user may replace the external object 420. When the external object 420 is replaced, a new second content may be obtained from the chip 422 included in the replaced external object 420. Since the second content is stored in memory (e.g., the memory 130 of FIG. 2), as the replacement of the external object 420 is repeated, a capacity of the second content stored in the memory 130 may increase (e.g., additional second content can be stored in the memory 130 as the replacement of the external object 420 is repeated). As the capacity of the second content increases, an available capacity of the memory 130 may be insufficient. The electronic device 101 according to an embodiment may secure the capacity of the memory 130 by deleting second content that has not been used for a designated time.

Referring to FIG. 10, in operation 1001, the processor (e.g., the processor 120 of FIG. 2) may display the second content via the cover display 231.

For example, the processor 120 may download the second content from an external electronic device (e.g., the external electronic device 402 of FIG. 2) (e.g., a server) based on URI data obtained from a case (e.g., the case 401 of FIG. 2). The processor 120 may control the cover display 231 such that the downloaded second content is displayed via the cover display 231.

In operation 1003, the processor 120 may identify whether the case 401 and the electronic device 101 are separated.

For example, the processor 120 may identify coupling between the case 401 and the electronic device 101 via a first sensor (e.g., the first sensor 211 of FIG. 2). For example, when a detection object 421 in the frame 410 is positioned in a designated distance from the first sensor 211, the first sensor 211 may provide an electrical signal based on proximity of the detection object 421 to the processor 120. The processor 120 may identify that the case 401 is coupled to the electronic device 101 based on the electrical signal provided from the first sensor 211. For example, when the case 401 is separated from the electronic device 101, the detection object 421 in the frame 410 may move outside the designated distance from the first sensor 211. The first sensor 211 may provide an electrical signal based on separation of the detection object 421 to the processor 120. The processor 120 may identify that the case 401 is separated from the electronic device 101 based on the electrical signal provided from the first sensor 211.

In the operation 1003, when the processor 120 identifies that the coupling between the case 401 and the electronic device 101 is maintained, operation 1005 may be performed. In the operation 1005, the processor 120 may maintain display of the second content. For example, in a case in which the case 401 is not separated from the electronic device 101 and maintains the coupling with the electronic device 101, the processor 120 may maintain display of the second content. For example, the processor 120 may control the cover display 231 such that the second content is displayed via the cover display 231.

In the operation 1003, when the processor 120 identifies separation between the case 401 and the electronic device 101, operation 1007 may be performed. In the operation 1007, the processor 120 may stop displaying the second content.

For example, the user may separate the case 401 from the electronic device 101 to change the second content displayed on the cover display 231, or to stop displaying the second content. For example, the processor 120 may identify separation of the case 401 in a case in which the frame 410 coupled to an outer surface of the electronic device 101 is separated, or an external object 420 inserted into the frame 410 is extracted. The processor 120 may stop displaying the second content based on identifying the separation of the case 401.

In operation 1009, the processor 120 may identify whether a designated period has elapsed (or expired) from or based on a timing at which display of the second content was stopped.

For example, the processor 120 may identify a timing at which the case 401 was separated. The timing at which the case 401 was separated may be referred to as the timing at which display of the second content was stopped. If another external object 420 is inserted into the frame 410 for display of another second content, the processor 120 may display the other second content via the cover display 231. Display of the other second content may be distinguished from the second content for which display was stopped. For example, the designated period may be a period during which the user may be presumed to have separated the case 401 with an intention of not reusing the stopped second content for a while. For example, the designated period may be referred to as one week (7 days), but is not limited thereto.

In the operation 1009, when the processor 120 identifies that the designated period has elapsed from the timing, operation 1011 may be performed. In the operation 1011, the processor 120 may delete the second content stored in the memory 130.

For example, when the designated period has elapsed from the timing at which display of the second content was stopped, the processor 120 may delete the second content downloaded to the memory 130. Since the second content has not been reused for a considerable period of time, the processor 120 may delete the second content to secure capacity of the memory 130.

In the operation 1009, when the processor 120 identifies that the designated period has not elapsed (e.g., not expired) from the timing, operation 1013 may be performed. In the operation 1013, the processor 120 may maintain the second content stored in the memory 130. For example, when the designated period has not elapsed from the timing at which display of the second content was stopped, the user may insert the external object 420 corresponding to the second content into the frame 410 to display the second content again. Since the second content downloaded to the memory 130 has not been deleted, when the user inserts the external object 420 into the frame 410, the second content stored in the memory 130 may be displayed via the cover display 231 without needing to be downloaded again. Since the second content has not been deleted, time required to re-download the second content is not needed, and the second content may be displayed again promptly.

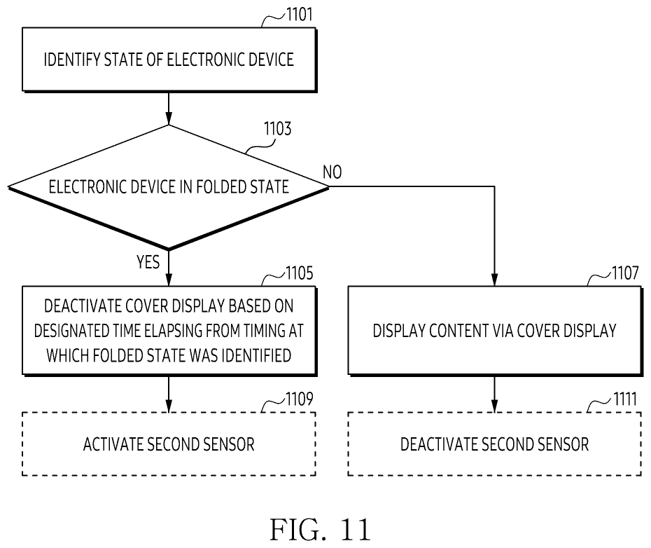

FIG. 11 is a flowchart of an operation based on a state of an electronic device according to an embodiment.

Operations described in FIG. 11 may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 11, in operation 1101, the processor (e.g., the processor 120 of FIG. 2) may identify a state of the electronic device (e.g., the electronic device 101 of FIG. 2).

For example, the electronic device 101 may include a third sensor (e.g., the third sensor 213 of FIG. 2) used to identify a state (e.g., a folded state, an unfolded state, and/or an intermediate state) of the electronic device 101. The third sensor 213 may include one or more magnets and/or one or more magnetic sensors. At least one of the one or more magnets or the one or more magnetic sensors included in the third sensor 213 may be disposed at different positions in the electronic device 101. A positional relationship of the one or more magnets and/or the one or more magnetic sensors in the electronic device 101 may be changed according to the state of the electronic device 101. The electronic device 101 may measure a change in the positional relationship via the one or more magnetic sensors. The change in the positional relationship may cause a change in a magnetic field formed by the one or more magnets. The electronic device 101 may obtain an electrical signal indicating the change in the magnetic field by using the third sensor 213. For example, the electronic device 101 may identify the state of the electronic device 101 using the electrical signal obtained from the third sensor 213.

In operation 1103, the processor 120 may identify whether the state of the electronic device 101 is a folded state. For example, the processor 120 may identify whether the electronic device 101 is in the folded state based on the electrical signal provided from the third sensor 213. For example, the processor 120 may identify that the electronic device 101 is transitioned from the unfolded state to the folded state.

In the operation 1103, when the processor 120 identifies the folded state of the electronic device 101, operation 1105 may be performed. In the operation 1105, the processor 120 may deactivate a cover display (e.g., the cover display 231 of FIG. 2) based on a designated time elapsing from a timing at which the folded state was identified.

For example, when the electronic device is in the folded state, the electronic device 101 may not be used by a user. For example, when content is continuously displayed via the cover display 231 while the user is not using the electronic device 101 in the folded state, unnecessary power consumption may be caused. The processor 120 may reduce unnecessary power consumption by deactivating the cover display 231 based on the designated time elapsing from the timing at which the folded state was identified. The designated time may be approximately 30 seconds, but is not limited thereto. The designated time may be preset by the user.

In the operation 1103, when the processor 120 does not identify the folded state of the electronic device 101, operation 1107 may be performed. In the operation 1107, the processor 120 may display content through the cover display 231.

For example, when the electronic device 101 is in the unfolded state and/or the intermediate state, the electronic device 101 may be used by the user. For example, while the user is using the electronic device 101 in the unfolded state and/or the intermediate state, content may be displayed via the cover display 231. User experience may be enhanced while the electronic device 101 is being used by the user, as the content is displayed via the cover display 231.

For example, the electronic device 101 may include a second sensor (e.g., the second sensor 212 of FIG. 2) for a user input (e.g., a touch input) provided via the cover display 231. For example, the second sensor 212 may include a touch sensor. For example, the processor 120 may be configured to identify a user input provided via the cover display 231, via the second sensor 212. According to an embodiment, the second sensor 212 may operate based on the state of the electronic device 101.

For example, in operation 1109, the processor 120 may activate the second sensor 212. For example, when the electronic device 101 is in the folded state, the processor 120 may identify a user input for the cover display 231 via the activated second sensor 212. In the folded state, since a flexible display 232 is not visible from the outside, a user input for the flexible display 232 may not be possible. The electronic device 101 according to an embodiment may activate the second sensor 212 to receive a user input for the cover display 231 in the folded state in which a user input for the flexible display 232 is not receivable.

For example, in operation 1111, the processor 120 may deactivate the second sensor 212. For example, when the electronic device 101 is in the unfolded state, the processor 120 may receive a user input provided via the flexible display 232 exposed to the outside. The electronic device 101 according to an embodiment may deactivate the second sensor 212 to block a user input for the cover display 231 in the unfolded state in which a user input for the flexible display 232 is receivable.

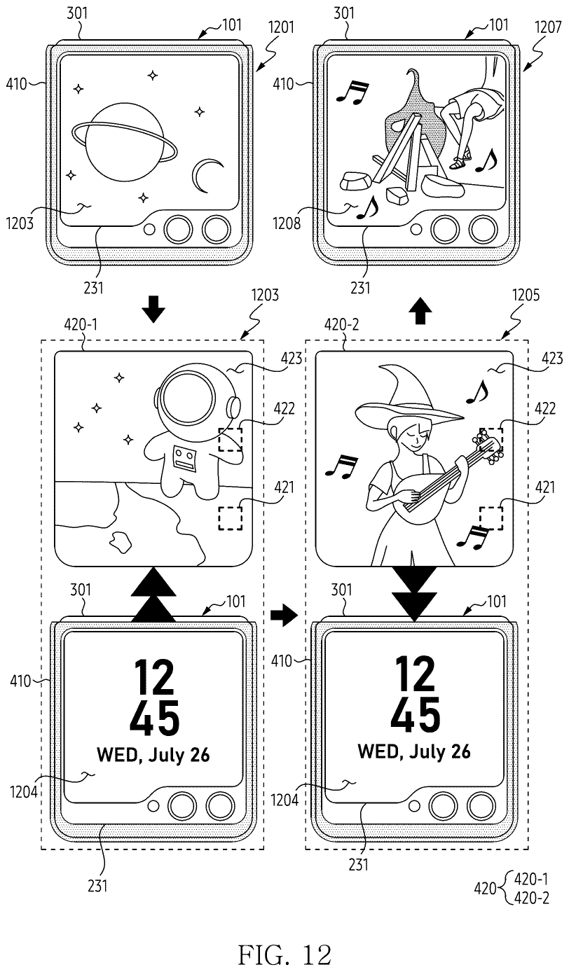

FIG. 12 illustrates an exemplary process for changing content displayed on a cover display.

Referring to FIG. 12, the content displayed on a cover display 231 may be performed by changing an external object 420 that includes a chip 422.

For example, a case 401 may include a frame 410 and the external object 420. The frame 410 may be coupled to an electronic device 101, and the external object 420 may be inserted into the frame 410.

Referring to a state 1201, in a state in which the case 401 is coupled, content may be displayed via the cover display 231. For example, a state 1201 may be referred to as a state in which a first external object 420-1 is inserted into the frame 410. In a state in which the first external object 420-1 is inserted, a screen 1202 including content corresponding to the first external object 420-1 may be displayed via the cover display 231.

Referring to a state 1203, when the first external object 420-1 is extracted from the frame 410, the electronic device 101 may identify that the case 401 is separated via a first sensor (e.g., the first sensor 211 of FIG. 2). For example, as a distance between the first sensor 211 and a detection object 421 exceeds a designated distance, the processor 120 may identify separation between the case 401 and the electronic device 101. Based on identifying the separation, the processor 120 may stop displaying the content corresponding to the first external object 420-1 via the cover display 231. When display of the content corresponding to the first external object 420-1 is stopped, the cover display 231 may display a basic screen 1204. For example, the basic screen 1204 may be referred to as a screen that does not include content. For example, the basic screen may display basic information such as time and date.

Referring to a state 1205, a second external object 420-2, different from the first external object 420-1, may be inserted into the frame 410. For example, the chip 422 included in the second external object 420-2 may include information different from that in the chip 422 included in the first external object 420-1. When the second external object 420-2 is inserted into the frame 410, the electronic device 101 may identify coupling of the case 401 via the first sensor 211. For example, when a distance between the first sensor 211 and the detection object 421 is in the designated distance, the processor 120 may identify coupling between the case 401 and the electronic device 101.

Referring to a state 1207, content corresponding to the second external object 420-2 may be displayed. For example, the processor 120 may control the cover display 231 such that the content corresponding to the second external object 420-2 is displayed based on data obtained from the chip 422 included in the second external object 420-2. For example, a screen 1208 including the content corresponding to the second external object 420-2 may be displayed via the cover display 231. The content may be related to an image 423 included on a surface of the second external object 420-2.

According to an embodiment, as the external object 420 is replaced, the content displayed via the cover display 231 may be changed. Since various contents may be provided according to the external object 420, user experience may be enhanced.

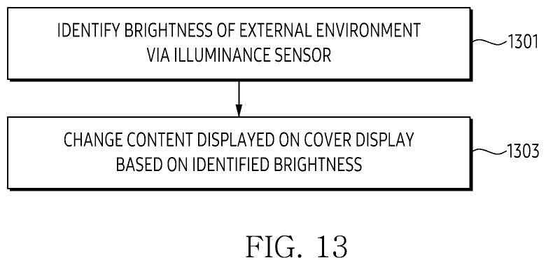

FIG. 13 is a flowchart of an operation of changing content based on an external environment.

Operations described in FIG. 13 may be operations caused by an electronic device (e.g., the electronic device 101 of FIG. 2) when instructions stored in memory (e.g., the memory 130 of FIG. 2) are executed by a processor (e.g., the processor 120 of FIG. 2).

Referring to FIG. 13, in operation 1301, the processor (e.g., the processor 120 of FIG. 2) may identify brightness of the external environment via an illuminance sensor.

For example, the electronic device (e.g., the electronic device 101 of FIG. 2) may include an illuminance sensor for identifying the brightness of the external environment of the electronic device 101. For example, the illuminance sensor may provide an electrical signal indicating the brightness of the external environment to the processor 120. The processor 120 may identify the brightness of the external environment based on the electrical signal.

In operation 1303, the processor 120 may change content displayed on a cover display (e.g., the cover display 231 of FIG. 2) based on the identified brightness.

For example, the processor 120 may adjust brightness of the content according to the brightness of the external environment. For example, when the processor 120 identifies that the brightness of the external environment is sufficient via the illuminance sensor, it may control the cover display 231 such that content that matches the brightness of the external environment is displayed via the cover display 231. For example, when the processor 120 identifies that the brightness of the external environment is insufficient via the illuminance sensor, it may control the cover display 231 such that a bright content is displayed via the cover display 231.

An electronic device 101 is provided. The electronic device 101 may comprise a first housing part 310. The electronic device 101 may comprise a second housing part 320. The electronic device 101 may comprise a hinge structure 365 rotatably connecting the first housing part 310 and the second housing part 320. The electronic device 101 may comprise a cover display 231 disposed on a surface (e.g., at least a portion of a second surface 312) of the first housing part 310. The electronic device 101 may comprise first wireless communication circuitry 221 configured to communicate using a first antenna 223. The electronic device 101 may comprise memory 130 including one or more storage media storing instructions. The electronic device 101 may comprise a processor 120 including processing circuitry. The instructions, when executed by the processor 120 individually or collectively, may cause the electronic device 101 to, based on identifying coupling between a case 401 and the electronic device 101 (e.g., the second housing part 320) via the first sensor 211, establish a communication channel with the case 401 via the first antenna 223 and the first wireless communication circuitry 221. The instructions, when executed by the processor 120 individually or collectively, may cause the electronic device 101 to obtain an identifier assigned to the case 401 and data related to content via the communication channel. The instructions, when executed by the processor 120 individually or collectively, may cause the electronic device 101 to identify content to be displayed via the cover display 231 based on the obtained data. The instructions, when executed by the processor 120 individually or collectively, may cause the electronic device 101 to control the cover display 231 such that the identified content is displayed via the cover display 231. The instructions, when executed by the processor 120 individually or collectively, may be configured to estimate state of charge (SOC) of a battery 189 while the content is displayed via the cover display 231. The electronic device 101 according to an embodiment may provide an enhanced user experience by displaying a screen including content via the cover display 231. To reduce power consumption according to display of content, the electronic device 101 may be configured to estimate the SOC of the battery 189 and control the cover display 231 based on the estimated SOC.

For example, the instructions, when executed by the processor 120 individually or collectively, may cause the electronic device 101 to maintain the content displayed via the cover display 231, based on estimating that the SOC of the battery 189 is equal to or greater than a threshold value. The instructions, when executed by the processor 120 individually or collectively, may cause the electronic device 101 to change the content displayed via the cover display 231, based on estimating that the SOC of the battery 189 is less than the threshold value. For example, when remaining capacity of the battery 189 is low, the content may be changed to reduce power consumption. For example, the changed content may consume less power than the content before the change.

For example, the instructions, when executed by the processor 120 individually or collectively, may cause the electronic device 101 to change the content by changing a dynamic image included in the content displayed on the cover display 231 to a static image.

For example, the instructions, when executed by the processor 120 individually or collectively, may cause the electronic device 101 to identify first content to be displayed via the cover display 231 from among contents stored in the memory 130, based on information related to the content included in the data. For example, the first content may be referred to as a preload content stored in the memory 130 in advance.

For example, the electronic device 101 may further comprise second wireless communication circuitry 222 configured to communicate through a second antenna 224. The instructions, when executed by the processor 120 individually or collectively, may cause the electronic device 101 to download second content from an external electronic device 402 via the second antenna 224 and the second wireless communication circuitry 222, based on the data. The instructions, when executed by the processor 120 individually or collectively, may cause the electronic device 101 to control the cover display 231 such that the stored second content is displayed via the cover display 231. For example, the second content may be referred to as a download content obtained from the external electronic device 402 (e.g., a server).

For example, the instructions, when executed by the processor 120 individually or collectively, may cause the electronic device 101 to identify uniform resource identifier (URI) data included in the data. The instructions, when executed by the processor 120 individually or collectively, may cause the electronic device 101 to obtain the second content via the second wireless communication circuitry 222 based on the identified URI data.

For example, the instructions, when executed by the processor 120 individually or collectively, may cause the electronic device 101 to maintain display of the content via the cover display 231, based on identifying that the coupling between the case 401 and the electronic device 101 is maintained via the first sensor 211. The instructions, when executed by the processor 120 individually or collectively, may cause the electronic device 101 to stop displaying the second content via the cover display 231, based on identifying that the case 401 and the electronic device 101 are separated via the first sensor 211. The instructions, when executed by the processor 120 individually or collectively, may cause the electronic device 101 to delete the downloaded second content, based on a designated period elapsing from a timing at which display of the second content is stopped. For example, the electronic device 101 may delete the second content that has not been used for a certain period of time to secure capacity (or increase available capacity) of the memory 130. As the second content that has not been used for a certain period of time is deleted, the capacity of the memory 130 may be secured (or increased).

For example, the instructions, when executed by the processor 120 individually or collectively, may cause the electronic device 101 to authenticate the case 401 based on the identifier. Authenticating the case 401 may include receiving the identifier, comparing the received identifier to a prestored identifier in memory 130, and confirming a match as the authentication. Authenticating the case 401 may include receiving the identifier in a predefined format, which is indicative of authentication. The instructions, when executed by the processor 120 individually or collectively, may cause the electronic device 101 to release the communication channel based on completion of the authentication. For example, if the communication channel is maintained while the coupling between the case 401 and the electronic device 101 is maintained, it may be difficult to establish a communication channel with an external electronic device (e.g., a credit card reader device) via the first antenna 223. For example, the processor 120 may be configured to release the communication channel based on the completion of the authentication to enable various functions provided using NFC communication. After the authentication is completed, by releasing the communication channel, the electronic device 101 may perform NFC with an external electronic device using NFC.

For example, the instructions, when executed by the processor 120 individually or collectively, may cause the electronic device 101 to identify the coupling of the case 401 based on identifying a detection object 421 included in an external object 420 inserted into a frame 410 of the case 401 via the first sensor 211. For example, the detection object 421 may be a magnet, and the first sensor 211 may be a Hall sensor. When the detection object 421 is positioned in a designated distance from the first sensor 211, the first sensor 211 may provide an electrical signal based on the detection object 421 to the processor 120. The processor 120 may identify the coupling of the case 401 based on the electrical signal.

For example, the electronic device 101 may further comprise a flexible display 232 disposed on another surface (e.g., a first surface 311 and a third surface 321) of the electronic device 101 opposite to the surface. The flexible display 232 may include a first display area 232a, a second display area 232b, and a third display area 232c. The first display area 232a may be disposed on the first housing part 310. The second display area 232b may be disposed on the second housing part 320. The third display area 232c may be disposed between the first display area 232a and the second display area 232b. The third display area 232c may be deformable based on the second housing part 320 that rotates relative to the first housing part 310.

For example, the cover display 231 may be disposed on a surface (e.g., the second surface 312) of the first housing part 310. The first antenna 223 may be disposed in the second housing part 320. The first antenna 223 may include an antenna for near field communication.

For example, the first housing part 310 may include a first surface 311 and a second surface 312 opposite to the first surface 311. The second housing part 320 may include a third surface 321 and a fourth surface 322 opposite to the third surface 321. The electronic device 101 may be switchable from a folded state in which a first direction faced by the first surface 311 and a second direction faced by the third surface 321 are the same, to an unfolded state in which the first direction is opposite to the second direction. The cover display 231 may be disposed on the second surface 312.

For example, the electronic device 101 may further comprise a second sensor 212 for a user input provided via the cover display 231. The processor 120 may be configured to identify the user input provided from the cover display 231 via the second sensor 212 in the folded state. The processor 120 may be configured to deactivate the second sensor 212 in the unfolded state.

For example, the processor 120 may be configured to activate the cover display 231 such that the content is displayed via the cover display 231, based on identifying the unfolded state of the electronic device 101.

For example, the processor 120 may identify the folded state of electronic device 101. The processor 120 may be configured to deactivate the cover display 231 based on a designated time elapsing from a timing at which the folded state is identified.

A method for an electronic device 101 is provided. The method may comprise identifying coupling between a case 401 and the electronic device 101 via a first sensor 211, establishing a communication channel with the case 401 via a first antenna 223 and first wireless communication circuitry 221 of the electronic device 101, obtaining an identifier assigned to the case 401 and data related to the content via the communication channel, identifying content to be displayed via a cover display 231 of the electronic device 101 based on the obtained data, controlling the cover display 231 such that the identified content is displayed via the cover display 231, and estimating state of charge (SOC) of a battery 189 of the electronic device 101 while the content is displayed via the cover display 231.

For example, the method may further comprise maintaining the content displayed via the cover display 231 based on estimating that the SOC of the battery 189 is equal to or greater than a threshold value, and changing the content displayed via the cover display 231 based on estimating that the SOC of the battery 189 is less than the threshold value.

For example, the method may further comprise identifying first content to be displayed via the cover display 231 from among contents stored in memory 130 based on information related to the content included in the data.

For example, the method may further comprise downloading second content from an external electronic device 402 via a second antenna 224 and second wireless communication circuitry 222 of the electronic device 101 based on the data, and controlling the cover display 231 such that the stored second content is displayed via the cover display 231.

The method may further comprise authenticating the case 401 based on the identifier and releasing the communication channel based on completion of the authentication.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for” or “means.”

What is claimed is:

1. An electronic device comprising:
a first housing part;
a second housing part rotatably connected to the first housing part;
a cover display disposed on at least a portion of a surface of the first housing part;
a first sensor;
first wireless communication circuitry configured to communicate using a first antenna;
memory including one or more storage media storing instructions; and
at least one processor including processing circuitry,
wherein the instructions, when executed by the at least one processor individually or collectively, cause the electronic device to:
based on identifying a coupling between a case and the second housing part via the first sensor, establish a communication channel with the case via the first antenna and the first wireless communication circuitry,
obtain an identifier assigned to the case and data related to content via the communication channel,
based on the data, identify the content to be displayed via the cover display,
display the content via the cover display, and
while the content is displayed via the cover display, estimate a state of charge (SOC) of a battery.

2. The electronic device of claim 1,
wherein the instructions, when executed by the at least one processor individually or collectively, cause the electronic device to:
based on estimating that the SOC of the battery is equal to or greater than a threshold value, maintain the content displayed via the cover display, and
based on estimating that the SOC of the battery is less than the threshold value, change the content displayed via the cover display.

3. The electronic device of claim 1,
wherein the instructions, when executed by the at least one processor individually or collectively, cause the electronic device to change the content by changing a dynamic image included in the content displayed on the cover display to a static image.

4. The electronic device of claim 1,
wherein the instructions, when executed by the at least one processor individually or collectively, cause the electronic device to, based on information related to the content included in the data, identify first content to be displayed via the cover display from among contents stored in the memory.

5. The electronic device of claim 1, further comprising second wireless communication circuitry configured to communicate using a second antenna,
wherein the content corresponds to first content, and
wherein the instructions, when executed by the at least one processor individually or collectively, cause the electronic device to:
based on the data, download second content from an external electronic device via the second antenna and the second wireless communication circuitry, and
display the second content via the cover display.

6. The electronic device of claim 5,
wherein the instructions, when executed by the at least one processor individually or collectively, cause the electronic device to:
identify uniform resource identifier (URL) data included in the data, and
based on the URL data, obtain the second content.

7. The electronic device of claim 5,
wherein the instructions, when executed by the at least one processor individually or collectively, cause the electronic device to:
based on identifying that coupling between the case and the second housing part is maintained via the first sensor, maintain display of the second content via the cover display,
based on identifying that the case is separated from the second housing part via the first sensor, stop displaying the second content via the cover display, and
based on a designated period elapsing from a timing at which display of the second content is stopped, delete the second content that was downloaded.

8. The electronic device of claim 1,
wherein the instructions, when executed by the at least one processor individually or collectively, cause the electronic device to:
authenticate the case based on the identifier, and
release the communication channel based on completion of the authentication.

9. The electronic device of claim 1,
wherein the instructions, when executed by the at least one processor individually or collectively, cause the electronic device to, based on identifying a detection object included in an external object inserted into a frame of the case via the first sensor, identify the coupling between the case and the second housing part.

10. The electronic device of claim 1, further comprising a flexible display,
wherein a portion of the flexible display is opposite to the cover display.

11. The electronic device of claim 1,
wherein the first antenna is disposed in the second housing part and includes an antenna for near field communication.

12. The electronic device of claim 1,
wherein the first housing part includes a first surface and a second surface opposite to the first surface, wherein the cover display is disposed on the second surface,
wherein the second housing part includes a third surface and a fourth surface opposite to the third surface, and
wherein the electronic device further comprises a hinge structure rotatably connecting the first housing part and the second housing part to provide a folded state in which a first direction of the first surface corresponds to a second direction of the third surface, and an unfolded state in which the first direction is opposite to the second direction.

13. The electronic device of claim 12, further comprising a second sensor for identifying a user input provided via the cover display,
wherein the instructions, when executed by the at least one processor individually or collectively, cause the electronic device to,
identify the user input provided from the cover display via the second sensor when the electronic device is in the folded state, and
deactivate the second sensor when the electronic device is in the unfolded state.

14. The electronic device of claim 12,
wherein the instructions, when executed by the at least one processor individually or collectively, cause the electronic device to, based on identifying that the electronic device is in the unfolded state, activate the cover display such that the content is displayed via the cover display.

15. The electronic device of claim 12,
wherein the instructions, when executed by the at least one processor individually or collectively, cause the electronic device to,
identify that the electronic device is in the folded state, and
deactivate the cover display based on a designated time elapsing from a timing at which the folded state is identified.

16. A method performed by an electronic device comprising:
identifying a coupling between a case and the electronic device via a first sensor of the electronic device;
establishing a communication channel with the case via a first antenna and first wireless communication circuitry of the electronic device;
obtaining an identifier assigned to the case and data related to content via the communication channel,
identifying the content to be displayed via a cover display of the electronic device based on the data;
controlling the cover display such that the content is displayed via the cover display; and
estimating state of charge (SOC) of a battery of the electronic device while the content is displayed via the cover display.

17. The method of claim 16, further comprising:
maintaining the content displayed via the cover display based on estimating that the SOC of the battery is equal to or greater than a threshold value; and
changing the content displayed via the cover display based on estimating that the SOC of the battery is less than the threshold value.

18. The method of claim 16, further comprising:
identifying first content to be displayed via the cover display from among contents stored in memory based on information related to the content included in the data.

19. The method of claim 16, further comprising:
downloading second content from an external electronic device via a second antenna and second wireless communication circuitry of the electronic device based on the data, and controlling the cover display such that the second content is displayed via the cover display.

20. The method of claim 16, further comprising:
authenticating the case based on the identifier and releasing the communication channel based on completion of the authentication.
